(19) United States
(12) Patent Application Publication
(10) Pub. No.: US 2006/0089890 A1
(43) Pub. Date: Apr. 27, 2006

(54) Performance monitoring system, method and apparatus

(75) Inventor: Dallas Warren Campbell, Queensland (AU)

Correspondence Address: DILWORTH & BARRESE, LLP, 333 EARLE OVINGTON BLVD., UNIONDALE, NY, 11553, US

(73) Assignee: De Contrati Pty Ltd., Queensland 4061 (AU)

(21) Appl. No.: 10/543,245

(22) PCT Filed: Jan. 23, 2004
(86) PCT No.: PCT/AU04/00082

§ 371 Date: Jul. 25, 2005

(30) Foreign Application Priority Data
Jan. 23, 2003 (AU) 2003900322

(51) Int. Cl. G07F 19/00; H04M 15/00; G06Q 99/00

(52) U.S. Cl. 705/34; 705/1; 705/11

(57) ABSTRACT

A computer in a networked computer system is programmed to perform a performance monitoring method for an invoicing process, the invoicing process generating an invoice occupying one or more of a plurality of discrete states at any one time. The method includes the steps of defining performance criteria for at least part of the invoicing process, recording information relating to the invoice that may affect the performance criteria and analysing at least some of the recorded information to generate a performance report for at least part of the invoicing process, the performance report comparing a performance of at least part of the invoicing process against the performance criteria to provide an indication of the efficiency of at least part of the invoicing process.

### FIELD OF THE INVENTION

The invention relates to a performance monitoring system, method and apparatus. In particular, although not exclusively, the invention relates to a system, method and apparatus that monitor users' performance in dealing with the entire lifecycle of invoices including preparation, output, dispute handling, negotiation and payment of invoices.

### BACKGROUND TO THE INVENTION

Conventionally, once goods and/or services or the like have been provided by a supplier to a consumer, the consumer is invoiced for the goods and/or services and the invoice is to be paid within a specified time period.

In the economy there is an emerging difference in corporate behaviour in handling invoices related to tangible goods versus those related to intangibles such as services. Large corporations have very sophisticated procedures and computer systems to deal with the purchase of tangible goods. Purchase orders are issued, goods are delivered, clerks check goods received against the order and if everything matches then payment is made. Organisations with large and consistent purchasing arrangements such as retailers are so well organised they can achieve payment cycles as low as seven days and even derive early payment discounts from the vendors. In comparison, handling the acquisition and payment of intangible goods is much more difficult and variable. This results in much longer payment times for providers of intangible goods and services.

One reason for the difference in behaviour is because receipt of the intangible goods and services is a matter of opinion not fact. Physical goods can be counted, quality measured, and location determined, which is not always possible with intangible goods. Another reason is because the receipt of intangible goods and services is often handled directly by a user who may be employed in any position within the buying organisation and the buying organisation usually does not have the sophisticated processes to support these users/buyers in the same way that the dedicated receiver clerk is supported by the corporate computing infrastructure.

That the receipt of goods is based on opinion means that there may be uncertainty about the final value of an invoice that is mutually acceptable to both the supplier and buyer. In other words the invoice itself becomes a negotiation, which adds considerably to the time between provision of the goods/services and payment and to the transaction costs involved.

The lack of dedicated receiver support systems and training means that the user/buyer often does not fully understand how their own procurement systems operate and the exact formalities with which an invoice must conform. This may result in inaccuracies in the details of the invoice, which necessitates cancellation of the original invoice, sometimes via the creation of credit notes, and the issuance of a replacement invoice comprising amended details. Not only is this inefficient, but payment will be delayed and there may be further disagreement between the supplier and the consumer regarding payment due dates. Furthermore, whilst invoices are being amended following the identification of a discrepancy, the reason(s) for delays in payment are often not apparent.

The aforementioned payment problem has been well recognised and specific parts of the invoice life cycle have been addressed to a certain extent by automated document management systems and methods with which the prior art base is replete. For example, there are many systems and methods concerned with the generation, distribution and payment of invoices including the issuance of reminders when invoices are overdue for payment.

One such electronic billing system, which replaces the preparation and mailing of paper statements with electronic statement presentment, is disclosed in U.S. Pat. No. 5,963,925 assigned to Visa International Service Association. Although this system facilitates the electronic payment of invoices by multiple customers of multiple billers irrespective of the customers' financial institution and minimises the relationships needing to be established between billers and service providers, this system does not provide means for modifying aspects of the invoice in the event of a dispute between the biller and the customer. Many other systems permit multiple modifications of invoices by suppliers prior to issuance, but do not permit modification once the invoice has been issued.

One system that offers a degree of invoice construction flexibility is disclosed in U.S. Pat. No. 6,282,552 assigned to Daleen Technologies, Inc. This system allows the sender of an electronic invoice to specify portions of the invoice that are changeable by one or more recipients of the invoice and tracks the changes to the invoice data made by the recipients.

Another system and method for electronic invoice presentment is disclosed in US Patent Application No. 2002/0184123 assigned to Sun Microsystems, Inc. This system and method includes an electronic invoice dispute resolution process that is invoked when line items of an invoice are rejected by a designated approver associated with a purchasing entity. A provider resolution process is invoked to enable the provider of the goods/services to dispute or approve the disputed line items and the results of this provider resolution process are made available to the purchasing entity.

Other responses to the aforementioned problems can be seen in the wide array of payment systems that are available, from traditional cash and cheque payments to more modern approaches such as third party credit, electronic funds transfer, and payment hubs.

Some industries have tried to address the issue of payment negotiation by initially recognising this fact and developing specific practices to address these issues. An example of such an industry is the Australian construction industry. The practice of many of the large project management firms is to have monthly reviews of progress with sub-contractors and to negotiate a progress payment. The construction firms then have special dispensation from the Australian Tax Office to generate invoices on behalf of the subcontract vendors.

All of these approaches illustrate that endeavours to achieve efficient payment are widespread and clearly highly desirable. Additionally, the response required varies from industry to industry and from firm to firm. With so many responses and tools being available, the issue then becomes which is the right one for any given vendor to use and in which circumstance. Although some systems and methods allow invoices to be disputed, negotiated and amended prior to being finalised they do not identify inefficiencies in the invoice generation, finalisation and settlement procedure.

Hence, there is a need for a system, method and/or apparatus that addresses or at least ameliorates one or more of the aforementioned problems and/or provides a useful commercial alternative. Preferably, such a system, method and/or apparatus should identify inefficiencies in the invoice process.

In this specification, the terms “comprises”, “comprising”, “includes” or “including” or similar terms are intended to mean a non-exclusive inclusion, such that a method, system and/or apparatus that comprises a list of elements and/or steps does not include those elements and/or steps solely, but may well include other elements and/or steps not listed.

### SUMMARY OF THE INVENTION

According to one aspect, although it need not be the only or indeed the broadest aspect, the invention resides in a performance monitoring method for an invoicing process, said invoicing process generating an invoice occupying one or more of a plurality of discrete states at any one time during said invoicing process, said method including the steps of:

a) defining performance criteria for at least part of said invoicing process;

b) recording information relating to the invoice that may affect said performance criteria; and

c) analysing at least some of said recorded information to generate a performance report for at least part of the invoicing process, said performance report comparing a performance of at least part of the invoicing process against said performance criteria to provide an indication of the efficiency of at least part of said invoicing process.

Preferably, the step of defining the performance criteria includes performing step b) and step c) for an initial period.

Preferably, the step of recording information includes recording one or more of the following: a duration for which the invoice occupies one or more of said discrete states, a before state and an after state of the invoice for a transition between said discrete states, an action that triggers a transition between said discrete states, an identity of a user or system element which performs said action that triggers a transition between said discrete states, a communication prior to an action that triggers a transition between said discrete states, information which impacts on the action that triggers a transition between said discrete states, a medium through which said invoice is published, a number of times an invoice occupies a discrete state, a cost associated with each action relating to the invoice.

The step of recording a duration for which the invoice occupies each said discrete state may include recording a time and date of a transition between said discrete states.

Suitably, the invoicing process comprises nine discrete states, which may include the states: under construction, awaiting approval, publish legal, publish draft, accept legal, queried, edit, cancelled, closed.

Suitably, the number of discrete states in the invoicing process may change over time.

Preferably, the method further includes the step of defining actions that trigger transitions between the discrete invoice states.

Preferably, the method further includes the step of defining conditions that must be satisfied to permit specific transitions between discrete invoice states to occur.

Suitably, the method further includes the step of restricting the users who are permitted to initiate state transitions.

Suitably, the method further includes the step of restricting information relating to the invoice that may be viewed or changed by a user.

Preferably, the method further includes the step of defining one or more associations between the actions that trigger transitions and the transitions to enable the cause of a transition to be determined.

Preferably, the method further includes the step of defining conditions that must be satisfied to permit specific transitions between discrete invoice states to occur.

Preferably, the method further includes the step of defining one or more associations between actions that may be performed on invoices and the discrete invoice states to specify invoice actions that are permitted for the invoice in each respective state.

The method may further include recording at least some of the information relating the invoice for a time period before and a time period after a change is introduced to the invoicing process to determine the effect of the change.

According to another aspect, the invention resides in a performance monitoring system for an invoicing process, said invoicing process generating an invoice occupying one or more of a plurality of discrete states at any one time during said invoicing process, said system comprising:

a supplier machine for a supplier of the goods and/or services to which the invoice relates;

a buyer machine for a buyer of the goods and/or services to which the invoice relates;

an administrator machine coupled to be in communication with said supplier machine and said buyer machine via a communications network, said administrator machine performing the steps of:
a) defining performance criteria for at least part of said invoicing process;
b) recording information relating to the invoice that may affect said performance criteria; and
c) analysing at least some of said recorded information to generate a performance report for at least part of the invoicing process, said performance report comparing a performance of at least part of the invoicing process against said performance criteria to provide an indication of the efficiency of at least part of said invoicing process.

Preferably, the system further comprises a data store in communication with the administrator machine for storing one or more associations between the actions that trigger transitions and the transition to enable the determination of the cause of a transition.

Preferably, the data store also stores one or more associations between actions that may be performed on the invoices and the discrete invoice states to specify invoice actions that are permitted for the invoice in each respective state.

Preferably, the system further comprises a third party machine coupled to be in communication with said supplier machine, said buyer machine and/or said administrator machine via said communications network for sending and/or receiving information relating to the invoice that may affect said performance criteria.

According to a further aspect, the invention resides in a computer in a networked computer environment, said computer programmed to perform a performance monitoring method for an invoicing process, said invoicing process generating an invoice occupying one or more of a plurality of discrete states at any one time during said invoicing process, said method including the steps of:

a) defining performance criteria for at least part of said invoicing process;

b) recording information relating to the invoice that may affect said performance criteria; and

c) analysing at least some of said recorded information to generate a performance report for at least part of the invoicing process, said performance report comparing a performance of at least part of the invoicing process against said performance criteria to provide an indication of the efficiency of at least part of said invoicing process.

Further features of the present invention will become apparent from the following description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 is a schematic representation of the system of the present invention;

FIG. 2 is a high level workflow diagram showing the main events in the lifecycle of an invoice;

FIG. 3 shows an example of a matrix which defines valid state transitions within the invoice cycle according to one embodiment of the present invention;

FIG. 4 is a diagram showing an example of permissible state transition s;

FIG. 5 shows an example of an invoice audit history log;

FIG. 6 shows an example of a basic analysis report generated by the present invention;

FIG. 7 illustrates the association between invoice states, invoice actions, users and conditions;

FIG. 8 illustrates the association between invoice actions, transitions between invoice states, users and conditions;

FIG. 9 is a flow chart illustrating the determination of whether actions within an invoice state are permitted;

FIG. 10 is a flow chart illustrating the determination of whether transitions between invoice states are permitted;

FIG. 10A is a flow chart showing method steps of the performance monitoring method;

FIG. 11 is a screenshot of an audit history for an invoice;

FIGS. 12A-12C show examples of performance reports comparing performance of a vendor company with that of an employee of the vendor company;

FIGS. 13A-13C show examples of performance reports comparing performance of a vendor company with that of a customer of the vendor company; and

FIG. 14 shows an example of a performance report for the overall lifecycle of the invoice for different invoice publishing methods.

### DETAILED DESCRIPTION OF THE INVENTION

The system, method and apparatus of the present invention pertain to the construction, delivery, follow-up, negotiation, payment and other actions associated with invoices, monitoring how and when these events occur and analyzing this recorded information to generate performance reports indicative of the efficiency or otherwise of the invoice process.

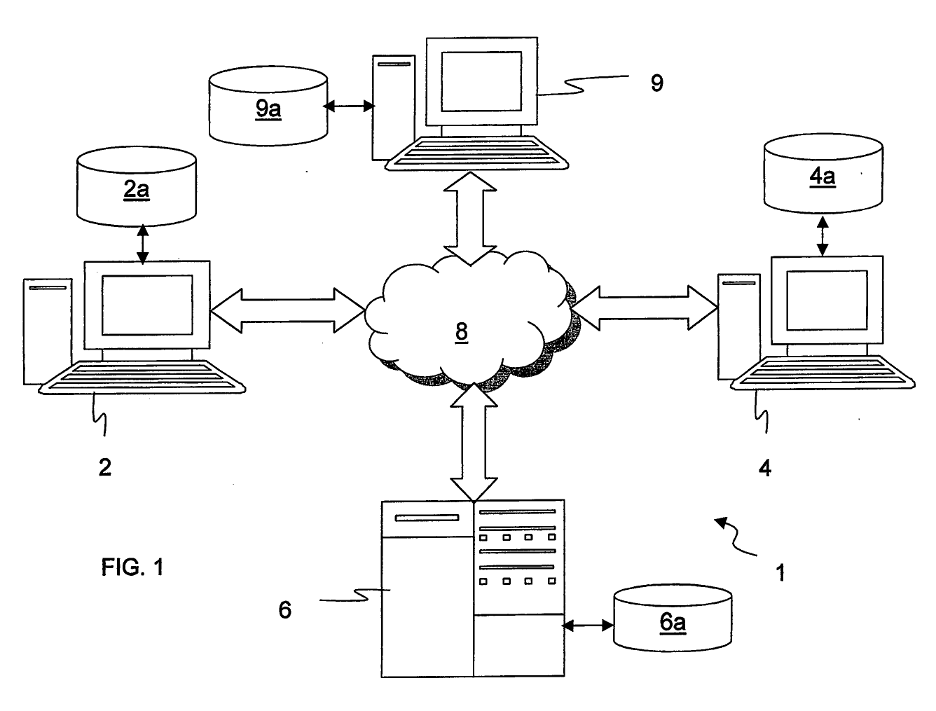

The present invention may be employed, for example, in the environment shown schematically in FIG. 1, which shows the system 1 of the present invention. The system comprises a supplier machine 2 of a supplier or vendor of goods and/or services or the like, a buyer machine 4 of a buyer of the goods and/or services provided by the vendor/supplier and an administrator machine 6.

Machines 2, 4, 6 are coupled to communications network 8, such as an intranet, LAN, WAN or global communications network such as the Internet.

In the example shown in FIG. 1, machines 2, 4 are in the form of conventional computer terminals and administrator machine 6 is in the form of an application server or mail server. However, it is also envisaged that supplier, buyer and/or administrator machines 2, 4, 6 could be mobile communication devices, such as hand-held PCs, suitably enabled mobile phones or personal digital assistants (PDAs) or the like. In such cases, communication network 8 will be or will include a telecommunications network.

Third parties 9 such as financial institutions and payment hubs may also interact with the machines 2, 4, 6 via the communications network 8 and are therefore also coupled to be in communication with machines 2, 4, 6 via the communications network 8, as shown in FIG. 1.

It will be appreciated that invoices, amendments thereto and agreements thereon and other communications relating to invoices may be communicated between a supplier, a buyer and administrator using conventional communication means such as mail and/or electronic means such as telephone, facsimile, the World Wide Web, email, SMS, EDI and/or other communication means.

In the embodiment shown in FIG. 1, the administrator machine 6 may be an application service provider (ASP) comprising one or more applications and a data store 6a such as a database for the provision of the invention to suppliers 2, buyers 4 and third parties 9. In such an embodiment, each of the suppliers 2, buyers 4 and third parties 9 may have their own dedicated information systems, 2a, 4a and 9a respectively, such as their accounting systems, which may store their general ledger (GL) as referred to later herein, their enterprise resource planning (ERP) systems, practice management systems and the like.

In alternative embodiments, some or all of the functions of the administrator terminal 6 are part of the supplier's system and/or the buyer's system and/or the system of the third party 9. In such embodiments, notifications of actions relating to the invoice and queries etc. are still transmitted over the communications network 8 or via the alternative communication means described above. This demonstrates that the workflow can exist across the supplier, buyer, third party and/or administrator.

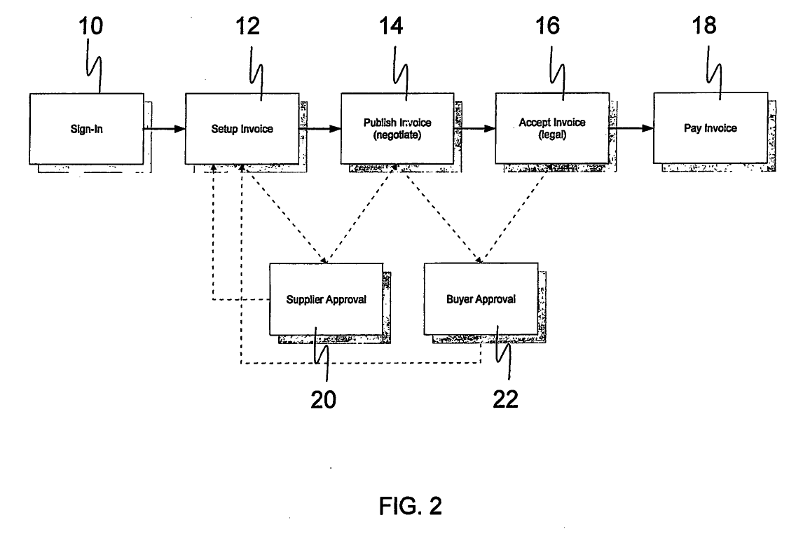

A high-level workflow diagram showing the main events in the life of an invoice is shown in FIG. 2. A user in the vendor organization signs in 10, and sets up 12 an invoice for a particular recipient according to the goods and/or services supplied. The invoice includes information that would conventionally appear in invoices, such as the type of goods/services supplied, the quantity provided, the cost per unit, total cost, the date supplied, tax, account number etc. The invoice is then published 14 and the buyer can indicate acceptance 16 of the debt owed in relation to the invoice prior to payment. The final stage in this example is payment 18 of the invoice.

As represented by blocks 20 and 22 and the dotted arrows in FIG. 2, the invoice may be negotiated and agreed upon by the supplier and/or the buyer before being accepted in step 16. For example, prior to publication, in step 20 the supplier may amend the invoice after set up and provide their approval prior to publication. Additionally, or alternatively, after publication, in step 22 the buyer may negotiate the invoice, which may necessitate amendments being made to the invoice by the user of the vendor organization and re-publication of the amended invoice. Once the contents of the invoice have been finalized into a legally binding state, the invoice will be entered in a general ledger (GL), which will render the relevant taxes payable.

However, it will be appreciated that other events can exist in the life of an invoice other than those shown in FIG. 2 and these are described hereinafter.

Placing an invoice publishing system within the environment described in FIG. 1, in which at least some of the supplier's, buyers' and/or third parties' activities relating to the invoice can be captured, creates the opportunity to monitor not only the stages an invoice goes through within the vendor organization, but also the opportunity to obtain important and useful data on certain stages of processing the invoice within the buyer and/or third party organization.

In one embodiment, the monitoring system, method and apparatus of the present invention recognize nine discrete states through which an invoice may pass during the lifecycle of the invoice. These states or phases are listed in Table 1 below:

TABLE 1

| Invoice State | Description |
|---|---|
| Under | “Under Construction” commences from the time that the vendor policy |
| Construction | and procedures state that an invoice should be issued. This can be at |
| | a nominated regular period such as at the start of the month or at |
| | specified milestones. During the construction phase the invoice |
| | components are assembled into a form ready for presentation. |
| | Construction can be automated or it can be a manual process carried |
| | out by a person authorised by the vendor. |
| Awaiting | The “Awaiting Approval” state allows for inspection and verification of an |
| Approval | invoice by a person authorised by the vendor. Generally there is a |
| | separation of duties between persons authorised to handle |
| | construction verses those given approval responsibility. |
| Publish | The “Publish Legal” state is when the vendor has issued an invoice to |
| Legal | the buyer that conforms fully to the format prescribed within the |
| | jurisdiction it is being issued. |
| Publish Draft | The “Publish Draft” state denotes when a preview of the final invoice |
| | is issued to the buyer. Generally this is done as a means to engage in |
| | negotiations about the final form of the invoice without placing it into a |
| | legal form. |
| Accept Legal | The invoice enters the “Accept Legal” state when the buyer has |
| | accepted the invoice in its final form but as yet has not paid the |
| | amount due. |
| Queried | The invoice enters the “Queried” state when the buyer raises some |
| | issue regarding the invoice. This may be an outright rejection that any |
| | debt exists, or general issues such as the amount, the content or a |
| | simple request for clarification. |
| Edit | This state is entered when changes to the invoice are to be made. |
| | This may include changes to the content or additions such as |
| | background information, or credit notes. |
| Cancel | The vendor can cancel an invoice and this ends the invoice process. |
| Close | An invoice is “Closed” when then entire transaction is complete. This |
| | occurs when the invoice amount equals the payments received plus |
| | credits and write offs. |

Invoice cycles begin with the invoice being “under Construction” and end with a state of either “Cancel” or “Close”. The various states recognize that in some instances draft invoices are used as a means of negotiation of a final amount. They also recognize that an invoice may have to go through a number of revisions or additions before the final transaction is concluded.

Although “Under Construction” is shown as the initial invoice state, a precursor state of “Invoice Start” or the like is often required in particular industries or companies wherein an invoice is issued at specified times, such as the start of each month, or at prescribed milestones. Other states may be required as dictated by, for example, the particular application or the jurisdiction. For example, in certain countries, invoices require a government stamp of approval, which necessitates at least one additional state. Hence, the invention is not limited to the nine states identified in the embodiment referred to above.

The invoice states in themselves do not imply a rigidly defined workflow or path that an invoice must take during its lifecycle. It will be appreciated that workflows can vary based on the work and accounting practices of the vendor and/or the buyer and/or the third party. It is envisaged that workflows and the number of discrete states in the invoice lifecycle may change over time to accommodate changing work practices. Furthermore, the workflow can exist across all parties involved in the invoicing process.

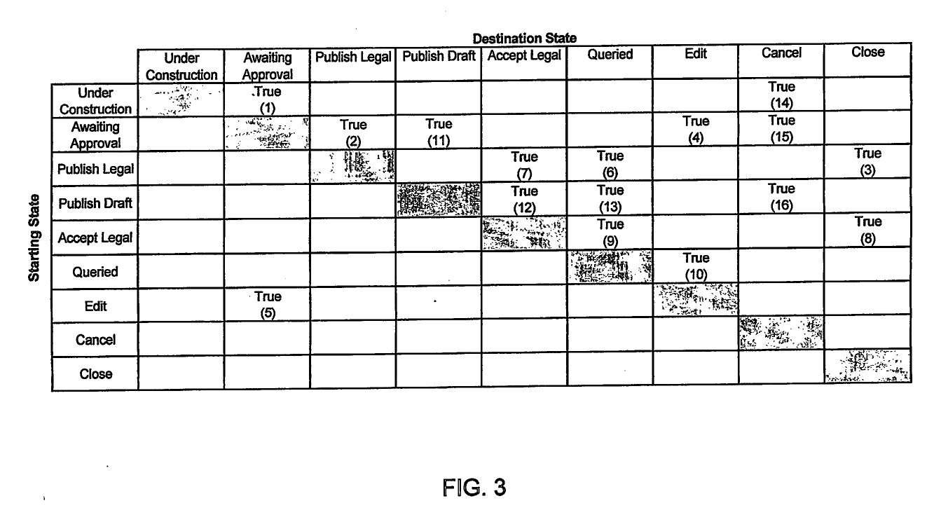

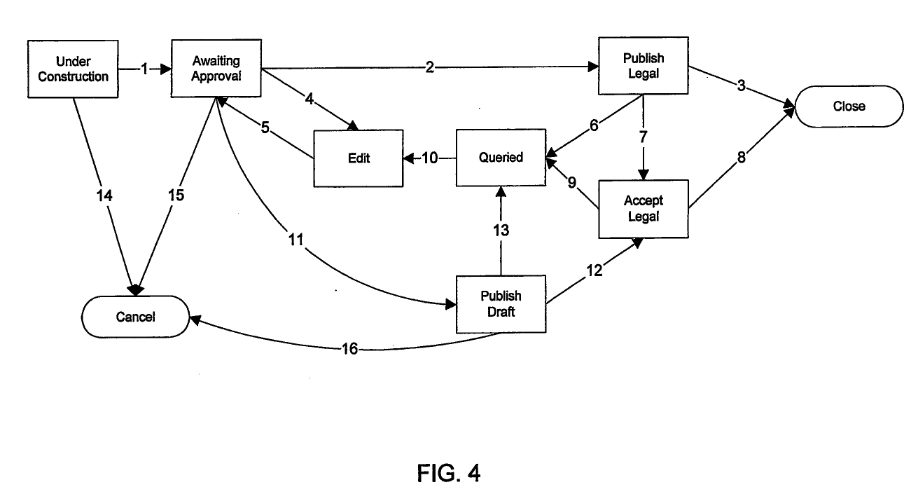

The possible paths can be constrained by specifying valid transitions between invoice states. This is shown in FIG. 3. FIG. 3 is an example of a matrix of valid state changes or transitions for an organization that is issuing both draft and legal invoices, where the buyer has the ability to approve or query an invoice. A valid state transition table can be described in a valid state transition diagram such as that shown in FIG. 4. The numbered valid transitions between invoice states shown in FIG. 4 correspond to the TRUE matrix entries shown in FIG. 3. Hence, an invoice that is in the state of, for example, “under construction” may validly move to a state of “awaiting approval” (transition 1) or to a state of “cancel” (transition 14), but not to a state of “publish legal”.

In many cases, the invoice will only occupy a single discrete state at any one time. However, it is envisaged that an invoice may simultaneously occupy more than one state. For example, part of an invoice may be in the state of awaiting approval and another part of the same invoice may be in the edit state. Another example could be where the invoice is awaiting buyer approval and simultaneously awaiting governmental approval. Such an example would require multiple approval states in parallel.

An example of the actions within a software application that trigger each state transition shown in FIGS. 3 and 4 are specified in Table 2 below:

TABLE 2

| State Transition | Trigger Action |
|---|---|
| 1 | Click “Ready to Publish” button |
| 2 | Click “Publish Legal” button |
| 3 | Click “Paid” or “Write off” button and entering |
| | outstanding amount exactly |
| 4 | Click “Edit” button |
| 5 | Click “Ready to Publish” button |
| 6 | Click “Query” button |
| 7 | Click “Accept” button |
| 8 | Click “Paid” or “Write off” button and entering |
| | outstanding amount exactly |
| 9 | Click “Query” button |
| 10 | Click “Edit” button |
| 11 | Click “Publish Draft” button |
| 12 | Click “Accept” button |
| 13 | Click “Query” button |
| 14 | Click “Cancel Invoice” |
| 15 | Click “Cancel Invoice” |
| 16 | Click “Cancel Invoice” |

The vendor organization can then define the workflow and company procedures by;
1. Specifying the actions which trigger each state change (illustrated in Table 2);
2. Restricting the users who may make a specific state change;
3. Defining prerequisites/conditions that allow a specific state change to occur;
4. Restricting the invoice or invoice related data which each user may view or change; and
5. Defining any prerequisites/conditions that enable users to make the changes.

An example of a prerequisite or condition for allowing a state transition to occur is that a user may not be allowed to move an invoice into a “Publish Draft” state if it has previously been through either a “Publish Legal” or “Accept Legal” state. An example of a prerequisite or condition for allowing specific aspects of the invoice to be modified within a state is that the invoice is in the “Edit” state. The user may only add notes to the buyer or credit notes of the invoice, but may not be able to change the specific content of the invoice if it has been through either a “Publish Legal” or “Accept Legal” state. However, the user may change the content of the invoice if it has never been through a “Publish Legal” or “Accept Legal” state, but may not add credit notes. It will be appreciated that further prerequisites or conditions may be specified that restrict the occurrence of state transitions.

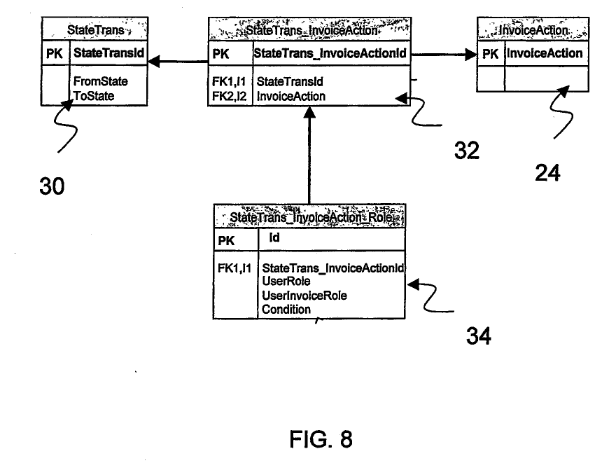

With reference to FIG. 7, each state in the workflow has a number of associated invoice actions, which identify the actions permitted for a particular invoice state. Invoice actions are specified in InvoiceAction table 24. This table and other tables and data referred to herein are preferably stored in a conventional data store associated and in communication with administrator machine 6, as familiar to one skilled in the art. The invoice actions permitted when an invoice is in each respective state are specified in State_InvoiceAction table 26. A number of roles and conditions are connected to each permitted state-action association, which are specified in State_InvoiceAction_Role table 28. Table 28 specifies either a UserRole or a UserInvoiceRole. Examples of UserRoles are supplier, buyer etc. Examples of UserInvoiceRoles are InvoiceOwner, InvoiceContact, InvoiceController etc. Table 28 also specifies one or more conditions or prerequisites associated with the invoice and/or action and a State_InvoiceActionId. The State_InvoiceActionId identifies the particular state-action association specified in State_InvoiceAction table 26. This arrangement enables rules to be specified such as “The invoice Owner (UserInvoiceRole) can Query (Action) the Invoice if it is in state Accept Legal (State) and it is non-web (Condition)” or A Controller (UserRole) can Edit (Action) any invoice (No Condition) when it is under Construction (State)”. Table 28 identifies who is allowed to do the specific actions that are permitted in the various discrete states and the associated conditions.

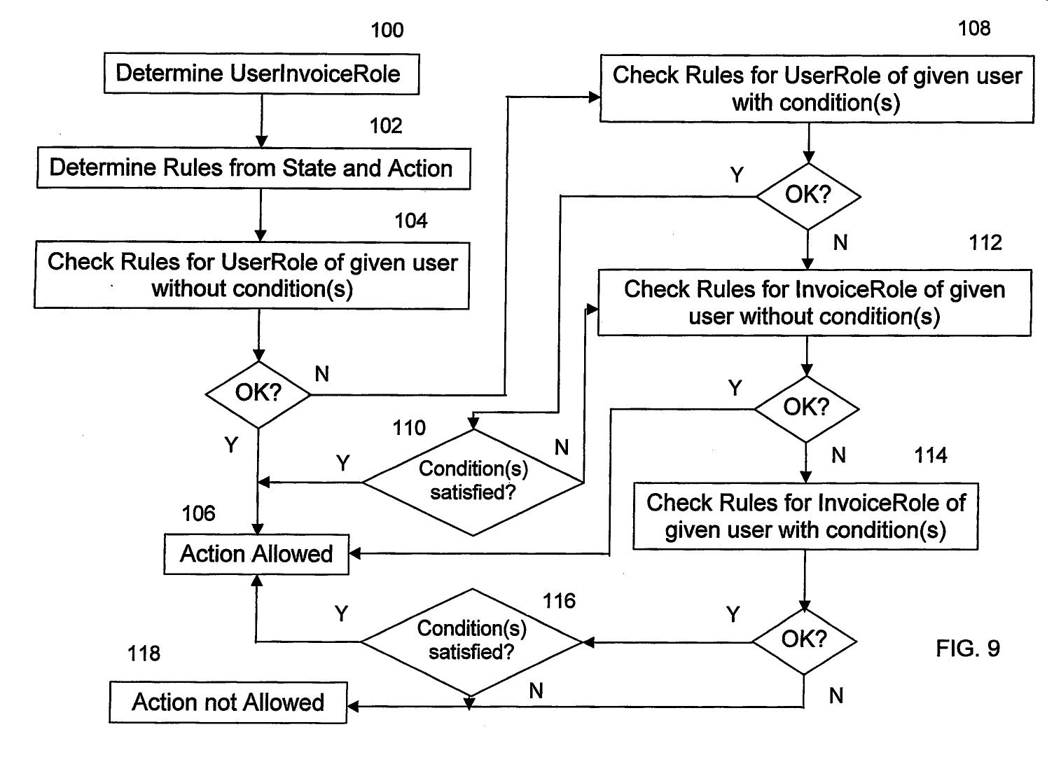

With reference to FIG. 8, the actions associated with particular invoice states are also associated with transitions between two states in the workflow. Invoice actions are specified in InvoiceAction table 24. Invoice transitions from one state (a before state or prior state) to another state (an after state) are specified in StateTrans table 30. The permitted invoice actions causing each permitted transition for each respective state are specified in StateTrans_InvoiceAction table 32 in the form of transition-action associations. This enables the identification of the action that triggers a transition. Each state will also have a transition to itself, since some actions don't trigger a change of state. Such actions may be associated with self-transitions. A number of roles and conditions or prerequisites are connected to each transition-action association, which are specified in the StateTrans_InvoiceAction_Role table 34. Table 34 specifies either a UserRole or UserInvoiceRole as described above for table 28 in FIG. 7. Table 34 also specifies one or more conditions associated with the invoice and/or action and a StateTrans_InvoiceActionid. The StateTrans_InvoiceActionId identifies the particular transition-action association specified in StateTrans_InvoiceAction table 32.

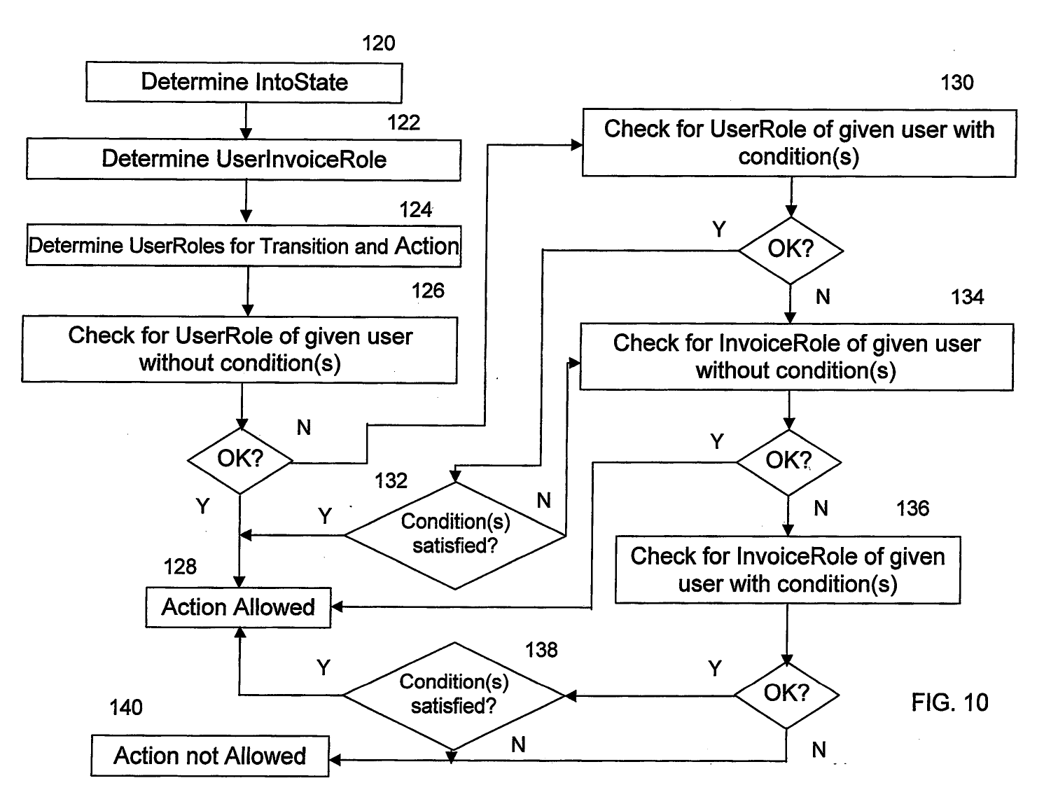

The method by which the present invention determines whether actions are permitted in particular states will now be described with reference to FIG. 9. In step 100, the UserInvoiceRole is identified from the User and the InvoiceId. In step 102, the rules stored in the State_InvoiceAction_Role table 28 are established based on the invoice state and the InvoiceAction. The rules for the particular UserRole of a given user in the absence of any conditions are checked, as represented by step 104. If valid, the action is allowed, step 106. If invalid, the rules for the particular UserRole of a given user with conditions are checked, as represented by step 108. If permitted, a check is made to determine whether the one or more conditions are satisfied, step 110. If so, the action is allowed, step 106. If the one or more conditions are not satisfied or the rules for UserRole of a given user are not permitted, the rules for InvoiceRole of a given user without conditions are checked, step 112. If permitted, the action is allowed, step 106. If not, the rules for InvoiceRole of a given user with conditions are checked, step 114. If invalid, the action is not allowed, step 118. If valid, a check is made to determine whether the one or more conditions are satisfied, step 116. If the condition(s) is/are satisfied, step 116, the action is allowed, step 106. If the condition(s) is/are not met, the action is not allowed, step 118.

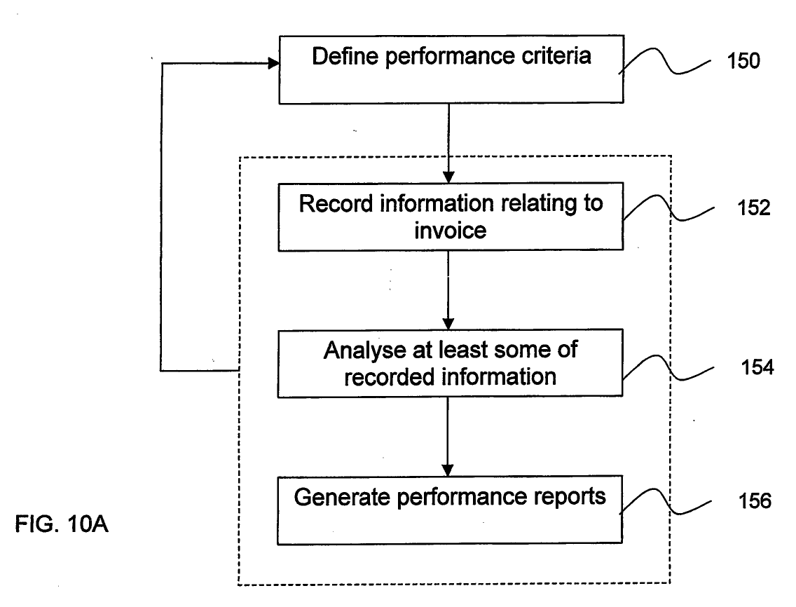

The method by which the present invention determines whether transitions from one state to another state are permitted will now be described with reference to FIG. 10. In step 120, the state into which it is proposed the invoice will move is determined from the InvoiceAction stored in table 24 and the fromstate (before state of the invoice) stored in table 30. In step 122, the UserInvoiceRole is identified from the User and the InvoiceId. The UserRoles for the Transition and the Action are determined from the intoState (after state of the invoice) and the fromState stored in table 30 and the InvoiceAction, as represented by step 124. The result is the data stored in the StateTrans_InvoiceAction_Role table 34.

The rules for the particular UserRole of a given user in the absence of any conditions are checked, as represented by step 126. If valid, the transition and therefore the action, is allowed, step 128. If invalid, the rules for the particular UserRole of a given user with conditions are checked, as represented by step 130. If permitted, a check is made to determine whether the one or more conditions are satisfied, step 132. If so, the transition is allowed, step 128. If the one or more conditions are not satisfied or the rules for UserRole of a given user are not permitted, the rules for InvoiceRole of a given user without conditions are checked, step 134. If permitted, the transition is allowed, step 128. If not, the rules for InvoiceRole of a given user with conditions are checked, step 136. If invalid, the transition is not allowed, step 140. If valid, a check is made to determine whether one or more condition(s) is/are satisfied, step 138. If so, the transition is allowed, step 128. If the condition(s) is/are not met, the transition is not allowed, step 140.

With reference to FIG. 10A, once the system and apparatus has been configured for one or more specific workflows, performance criteria are defined for at least part of the invoicing process, as represented by step 150, against which the performance of the invoicing process is compared. Performance monitoring then occurs by recording the information relating to the invoice that may affect the performance criteria, as represented by step 152.

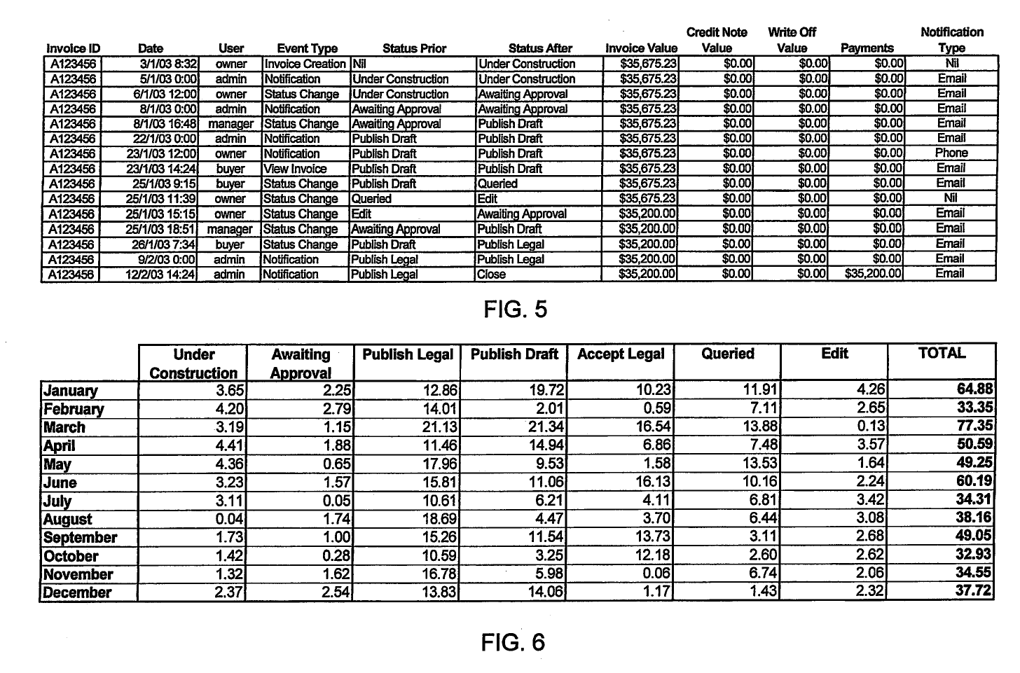

The recorded information may include the time of each state transition, the action and/or trigger which caused the transition, which user or system caused the state transition, the total value of the invoice, credit notes, write-offs, and payments. Other information may also be recorded such as notifications, e.g. communications impacting on the action/trigger event, specifics of the changes made such as reasons for write ups, write downs, discounts and the like, the number of times an invoice occupies or makes a transition through the discrete invoice states, changes to customer details and other such information. Hence, a complete transaction log of all changes and events that occur in the system that impact on the invoice in some way is created. An example of such a log for an invoice is shown in FIG. 5.

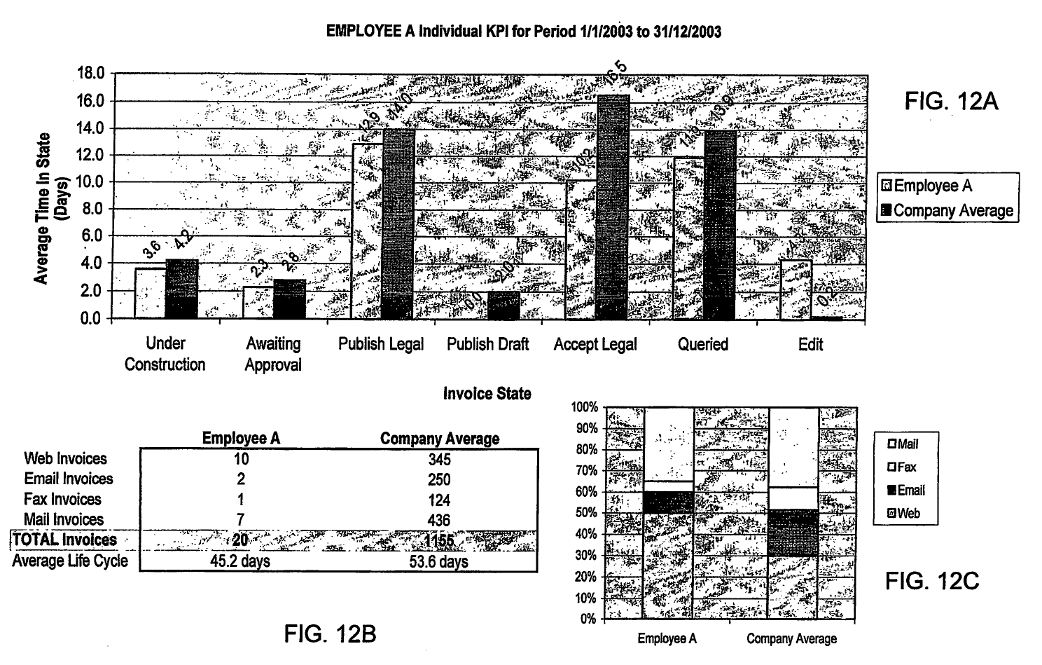

With further reference to FIG. 10A and steps 154 and 156, at least some of the recorded information is then analysed to generate one or more performance reports for at least part of the invoicing process, depending on which aspects of the invoicing process is being analysed. The performance reports compare the performance of the invoicing process against the performance criteria, thus providing an indication of the efficiency of the invoicing process or part thereof. Examples of such performance reports are shown in FIGS. 12A-14 and discussed in more detail later. As shown in FIG. 10A, definition of the performance criteria may include recording the invoice related information and analysing it for an initial period to obtain meaningful performance criteria.

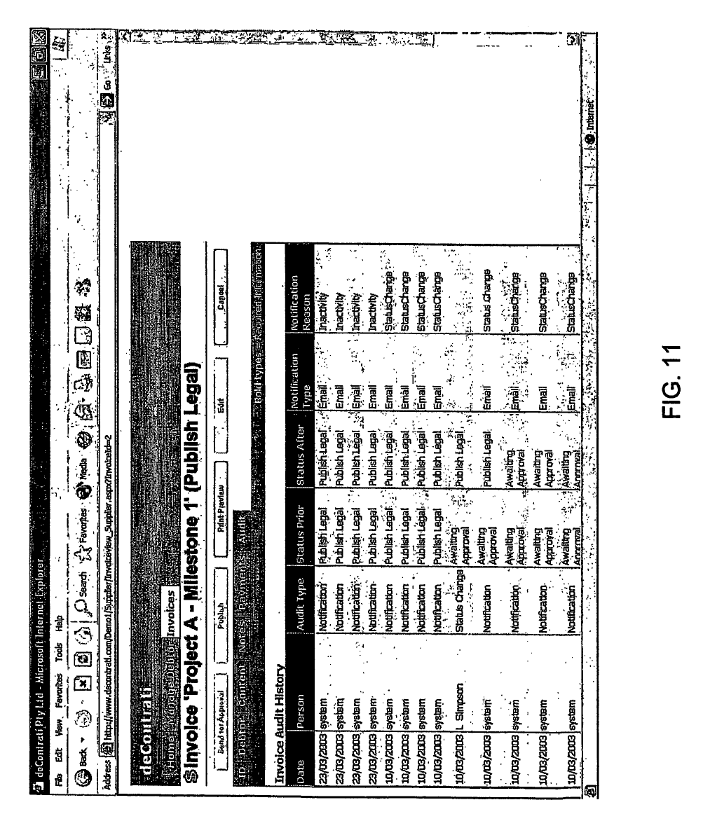

Another example of an audit history of an invoice is shown in the screenshot of FIG. 11. FIG. 11 shows the date of the logged event, the entity causing or effecting the event, which could be a user or a system element automatically effecting an event. FIG. 11 also shows the type of event. This may be a notification, such as a reminder to pay an unpaid invoice that is automatically generated by a system element, or change in invoice state. A state of the invoice prior to and after the logged event is also shown. The audit history of FIG. 11 also shows the method or type of notification, such as email, fax, verbal (such as telephone call) and the reason for the event, such as inactivity or a change in state of the invoice.

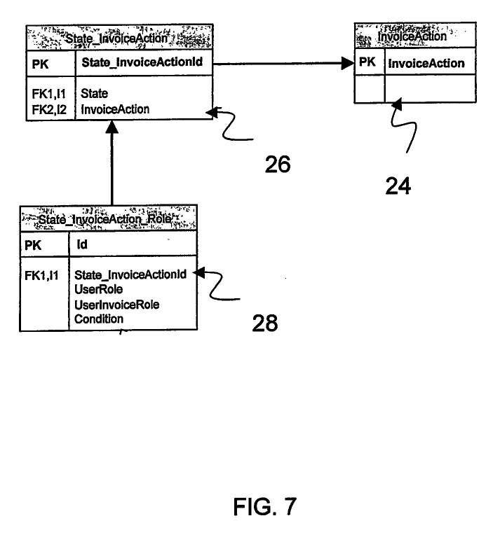

In one embodiment, the performance monitoring and analysis of the invention is achieved by recording the times and actions triggering the state transitions. The log of transition times and dates can then be converted into duration within a state and this information creates the basic performance analysis tool for determining the efficiency of the system and users of the system. The time within a state can then be reported in numerous ways. The most basic report would be the average time in each state for an accounting period, which is illustrated in FIG. 6. From such analysis inefficiencies in the invoice process can be identified and addressed.

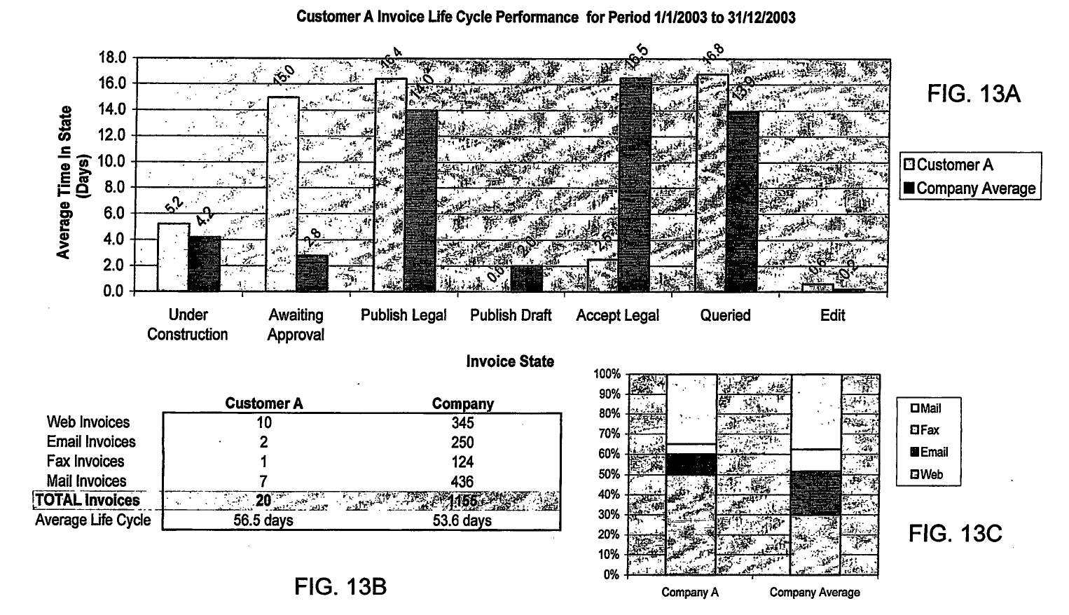

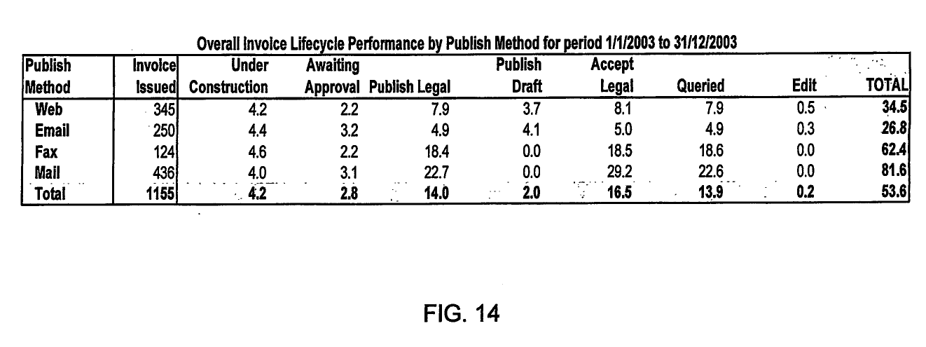

Further examples of the results of performance analysis are shown in FIGS. 12A-C, FIGS. 13A-C and FIG. 14 in the form of performance reports. FIGS. 12A-C compare the performance of a vendor company or supplier with the performance of an employee of that company. FIG. 12A shows the average time (in days) that invoices remain in a particular state over the period of one year. FIG. 12B shows the number of invoices published by the different methods of over the Internet, via email, via facsimile and by mail, a total number of invoices and the average lifecycle duration. FIG. 12C shows the percentages of a total number of invoices that are published by mail, fax, email or over the Internet.

FIGS. 13A-C show the same types of performance reports as those in FIGS. 12A-C, except that they compare the figures of customer A with those of the vendor company. This illustrates that the efficiency of both the issuer and payer of the invoice can be assessed.

FIG. 14 shows an example of a performance report for the overall lifecycle of the invoice for the different invoice publishing methods. This report shows the average time over the period of one year that invoices published by each method remain in each discrete invoice state.

In addition to the data that is recorded as described above and the aforementioned performance reports, other reports may be generated. For example, the cost associated with each action may be recorded in terms of, for example, employee time or an early payment discount and a performance report generated accordingly. Performance reports that illustrate the effect of a particular event may be produced such as reports generated before and after the introduction of an early payment discount. The performance reports may be made available to suppliers 2, buyers 4 and or third parties 9 as required, e.g. via the communications network 8 or via other communication means. Third parties 9 may also send and receive information relating to the invoice lifecycle via the communications network 8 or via other communication means. Such information may include copies of the invoice, the effecting of trigger events, such as making payments or changing a customer's status that may impact on the invoice.

Performance reports such as those described above identify and highlight trends in the invoice lifecycle including both efficient and inefficient parts therein and enable suppliers, customers and financial institutions to improve every aspect of their invoicing process.

Hence, the performance monitoring system, method and apparatus of the present invention addresses the problems of the prior art by recording not only the details of the invoice and changes thereto by the supplier and/or the buyer, but also by recording a range of other information relating to the invoice, such as a duration for which the invoice occupies one or more of said discrete states, a before state and an after state of the invoice for one or more transitions between states, one or more actions that trigger the state transitions, an identity of users or system elements which perform the actions that trigger transitions, communications prior to an action that triggers state transitions, information which impacts on the action that triggers state transitions, a medium through which the invoice is published, a number of times an invoice occupies a discrete state, and/or a cost associated with each action relating to the invoice.

This information is then analyzed to generate performance reports and determine the efficiency of the vendor's organisation as a whole, departments or employees of the vendor organisation, product lines, workflow, publishing method, customer groups and individual customers in dealing with the invoice in any or all parts of the invoice lifecycle from creation to settlement.

Throughout the specification the aim has been to describe the invention without limiting the invention to any one embodiment or specific collection of features. Persons skilled in the relevant art may realize variations from the specific embodiments that will nonetheless fall within the scope of the invention.

1. A performance monitoring method for an invoicing process, said invoicing process generating an invoice occupying one or more of a plurality of discrete states at any one time during said invoicing process, said method including the steps of:
a) defining performance criteria for at least part of said invoicing process;
b) recording information relating to the invoice that may affect said performance criteria; and
c) analysing at least some of said recorded information to generate a performance report for at least part of the invoicing process, said performance report comparing a performance of at least part of the invoicing process against said performance criteria to provide an indication of the efficiency of at least part of said invoicing process.

2. The method of claim 1, wherein the step of defining the performance criteria includes performing step b) and step c) for an initial period.

3. The method of claim 1, wherein the step of recording information includes recording one or more of the following: a duration for which the invoice occupies one or more of said discrete states, a before state and an after state of the invoice for a transition between said discrete states, an action that triggers a transition between said discrete states, an identity of a user or system element which performs said action that triggers a transition between said discrete states, a communication prior to an action that triggers a transition between said discrete states, information which impacts on the action that triggers a transition between said discrete states, a medium through which said invoice is published, a number of times an invoice occupies a discrete state, a cost associated with each action relating to the invoice.

4. The method of claim 3, wherein the step of recording a duration for which the invoice occupies each said discrete state includes recording a time and date of a transition between said discrete states.

5. The method of claim 1, wherein the invoicing process comprises nine discrete states.

6. The method of claim 5, wherein the nine discrete states include the states: under construction, awaiting approval, publish legal, publish draft, accept legal, queried, edit, cancel, close.

7. The method of claim 1, wherein the number of discrete states in the invoicing process changes over time.

8. The method of claim 1, further including the step of defining actions that trigger transitions between the discrete invoice states.

9. The method of claim 8, further including the step of defining one or more associations between the actions that trigger transitions and the transitions to enable the cause of a transition to be determined.

10. The method of claim 1, further including the step of defining conditions that must be satisfied to permit specific transitions between discrete invoice states to occur.

11. The method of claim 1, further including the step of defining one or more associations between actions that may be performed on invoices and the discrete invoice states to specify invoice actions that are permitted for the invoice in each respective state.

12. The method of claim 1, further including the step of restricting the users who are permitted to initiate state transitions.

13. The method of claim 1, further including the step of restricting information relating to the invoice that may be viewed or changed by a user.

14. The method of claim 3, further including recording one or more of the parameters in claim 3 for a time period before and a time period after a change is introduced to the invoicing process to determine the effect of the change.

15. A performance monitoring system for an invoicing process, said invoicing process generating an invoice occupying one or more of a plurality of discrete states at any one time during said invoicing process, said system comprising:
a supplier machine for a supplier of the goods and/or services to which the invoice relates;
a buyer machine for a buyer of the goods and/or services to which the invoice relates;
an administrator machine coupled to be in communication with said supplier machine and said buyer machine via a communications network, said administrator machine performing the steps of:
a) defining performance criteria for at least part of said invoicing process;
b) recording information relating to the invoice that may affect said performance criteria; and
c) analysing at least some of said recorded information to generate a performance report for at least part of the invoicing process, said performance report comparing a performance of at least part of the invoicing process against said performance criteria to provide an indication of the efficiency of at least part of said invoicing process.

16. The system of claim 15, further comprising a data store in communication with said administrator machine for storing one or more associations between the actions that trigger transitions and the transition to enable the determination of the cause of a transition.

17. The system of claim 15, further comprising a data store in communication with said administrator machine for storing one or more associations between actions that may be performed on invoices and the discrete invoice states to specify invoice actions that are permitted for the invoice in each respective state.

18. The system of claim 15, further comprising a third party machine coupled to be in communication with said supplier machine, said buyer machine and/or said administrator machine via said communications network for sending and/or receiving information relating to the invoice that may affect said performance criteria.

19. A computer in a networked computer environment, said computer programmed to perform a performance monitoring method for an invoicing process, said invoicing process generating an invoice occupying one or more of a plurality of discrete states at any one time during said invoicing process, said method including the steps of:
a) defining performance criteria for at least part of said invoicing process;
b) recording information relating to the invoice that may affect said performance criteria; and
c) analysing at least some of said recorded information to generate a performance report for at least part of the invoicing process, said performance report comparing a performance of at least part of the invoicing process against said performance criteria to provide an indication of the efficiency of at least part of said invoicing process.
